(19) United States
(12) Patent Application Publication
(10) Pub. No.: US 2014/0046619 A1
(43) Pub. Date: Feb. 13, 2014

(54) METHOD FOR DETERMINING A TEMPERATURE OF FUEL

(71) Applicant: Andreas Heinrich, Waiblingen (DE)

(72) Inventor: Andreas Heinrich, Waiblingen (DE)

(21) Appl. No.: 14/001,441

(22) PCT Filed: Feb. 2, 2012
(86) PCT No.: PCT/EP12/51739

§ 371 Date: Oct. 31, 2013

(30) Foreign Application Priority Data
Mar. 3, 2011 (DE) 10 2011 005 061.2
Jan. 13, 2012 (DE) 10 2012 200 457.2

(51) Int. Cl. G01K 7/16

(52) U.S. Cl. CPC G01K 7/16
USPC 702/130

(57) ABSTRACT

A method for determining a temperature of fuel in an injection system, in which the temperature of the fuel is ascertained as a function of a temperature of a coil of a metering unit of the injection system, a total resistance of the circuit of the metering unit being measured, and a proportion of a resistance of the coil in the total resistance of the circuit being calculated, and the temperature of the coil being calculated from the resistance of the coil.

### FIELD

The present invention relates to a method and a system for determining a temperature of fuel.

### BACKGROUND INFORMATION

Up to now, the temperature of the fuel in an injection system which is designed as a common rail system and whose control unit requires information about the temperature is ascertained by a temperature sensor which is installed in the inlet of the injection system. The temperature ascertained for the fuel makes it possible to ensure the injection of a fuel quantity at a particular point in time with the necessary degree of accuracy.

German Patent Application No. DE 199 46 910 A1 describes a method and a device for ascertaining the temperature of the fuel in a common rail system which has a suction-throttled high pressure pump and a metering unit, which electromagnetically actuates an actuating piston and varies a flow cross section, so that fuel is metered to the high pressure pump. The temperature of the fuel is ascertained by computer on the low pressure side at the inlet of the metering unit and on the high pressure side at the output of the high pressure pump with the aid of a stationary energy balance equation using the participating heat flows.

A method for calculating a temperature of the fuel at the inlet of an injection system of a motor vehicle is described in German Patent Application No. DE 10 2008 014 085 A1. A calculating unit is used for this purpose, which is suitable for calculating the temperature of the fuel as a function of a coil temperature-dependent, actual current through a coil of a metering unit for a common rail pump and a certain offset value between the temperature of the fuel and the temperature of the coil.

### SUMMARY

In carrying out an example method in accordance with the present invention, the metering unit (ZME) is used in connection with its activation for ascertaining the temperature of the fuel of an injection system, which may be designed, for example, as a common rail system.

The resistance of the coil of the metering unit is extracted, and the temperature of the coil is calculated therefrom by observing and/or taking into account the resistance of all components of a circuit of the metering unit. The temperature of the fuel is finally calculated on the basis of the temperature of the coil.

In one example embodiment, the resistances and, thus, the thermal dependencies of all components present in the circuit of the metering unit are usually taken into account. Electrical resistances of different components of the circuit of the metering unit, typically the coil, a no-load diode, an output stage, connectors, cables, a measuring resistor, etc., as well as their thermal dependencies, are thus taken into account. Moreover, all parameters of the pulse width modulated (PWM) activation, for example a battery voltage, a conducting-state voltage of the no-load diode, a pulse duty factor and the current flowing in the circuit of the metering unit, may be taken into account.

In the example method, among other things, a current controller may be used in the circuit of the metering unit, which corrects a deviation of an actual current from a setpoint current of the metering unit by varying the pulse duty factor of the output stage of the metering unit.

In one example embodiment of the present invention, the resistance is converted in the direction of a dropping coil voltage, which may be physically carried out on the basis of Ohm's Law. The temperature of the coil of the metering unit may furthermore be analytically calculated by taking into account the resistance of the circuit and the proportion of the resistance of the coil within the circuit. An analytical approach involving a heat exchange between the fuel and the coil is typically used, so that no offset value between the temperature of the fuel and that of the coil needs to be taken into account.

The temperature of the fuel is generally calculated with the aid of easily measurable parameters of the injection system, for example with the aid of the resistances and/or temperatures of the aforementioned components of the circuit of the metering unit. For this purpose, the entire resistance of the circuit of the metering unit is measured, and a proportion of a resistance of the coil in the total resistance of the circuit is calculated, the temperature of the coil being calculated from the proportion of the resistance of the coil in the total resistance of the circuit. The temperature of the fuel is ascertainable from the temperature of the coil.

During operation of the injection system, the fuel flows through a high pressure pump into which a slide valve of the metering unit projects. The heat of the fuel is transferred to the coil of the metering unit via the slide valve. Due to the heat transfer, the coil changes its electrical resistance on the basis of its thermal state. This change in resistance may be detected by a control unit in that it regulates the current during activation of the metering unit, and the temperature of the fuel may be determined from the change in resistance. A temperature sensor for the fuel, including its wiring, may thus be dispensed with, which may save installation space and weight. By dispensing with the temperature sensor, which is generally susceptible to errors, the reliability of the injection system may be increased. According to the present invention, an existing temperature sensor may still be monitored during an on-board diagnosis.

It is also possible to estimate the temperature of the fuel with the aid of an FTE (Fuel Temperature Emulation) function for emulating and/or simulating the temperature, which is based on operating parameters of the metering unit (ZME) of the injection system in connection with an activation of the injection system. To increase the accuracy of this FTE function, this function now includes an initialization of all components of a circuit of the metering unit, according to one embodiment of the present invention.

An additional initialization based on the FTE function, which is carried out in one implementation of the present invention, is used to determine which components in the circuit of the metering unit cause deviations from a resistance and/or are affected by a deviation of this type. Due to this measure, it is possible to optimize a calculation carried out with the aid of the FTE function and thus increase an accuracy of the FTE function.

By expanding the FTE function by the initialization, as described herein, each proportion of the tolerance resistance may generally be apportioned to an output stage, a diode and other components of the metering unit, usually the coil, by a maximum proportion. Due to this measure, it is possible to systematically increase a calculation accuracy of the temperature of the fuel.

In another embodiment of the present invention, the calculation of the voltage of the coil may be divided into two time ranges and thus phases with the aid of the pulse width modulated activation. For an activation phase, in which the battery voltage supplies the coil, voltage U_{coil,on} dropping across the coil may be calculated using equation (1), taking into account resistances of components of the circuit of the metering unit, in this case a cable harness (R_{cable}_{_{—}}ₕₐᵣₙₑₛₛ), a connector(R_{connector}), a measuring resistor (R_{measuring}_{_{—}}ᵣₑₛᵢₛₜₒᵣ) and an output stage (Rₒᵤₜₚᵤₜ_{_{—}}_{stage}), a current flowing through the circuit of the metering unit continuing to be taken into account.

U_{coil,on}=battery voltage−(R_{cable}_{_{—}}ₕₐᵣₙₑₛₛ+R_{connector}+R_{measuring}_{_{—}}ᵣₑₛᵢₛₜₒᵣ+Rₒᵤₜₚᵤₜ_{_{—}}_{stage})*current (1)

The equation (6) shown below should also be taken into account.

For a deactivation phase, in which the battery is disconnected from the coil via a switch, voltage U_{coil,off} dropping across the coil may be calculated using equation (2), taking a voltage of a diode into account, resistances of components of the circuit of the metering unit also being taken into account:

U_{coil,off}=diode voltage−(R_{cable}_{_{—}}ₕₐᵣₙₑₛₛ+R_{connector}+R_{measuring}_{_{—}}ᵣₑₛᵢₛₜₒᵣ)*current. (2)

The equation (7) shown below should also be taken into account.

The total voltage U_{coil} of the coil dropping across the coil of the metering unit during both time ranges is then:

U_{coil}=U_{coil,on}*(pulse duty factor)+U_{coil,off}*(1−pulse duty factor) (3)

It is provided that voltages U_{coil,on} and U_{coil,off} are provided as pulsed signals having a length T of one period and a length t of one pulse during a period. The pulse duty factor is then derived from the quotient t/T of length t of the pulse and length T of the period.

Resistance R_{coil} of the coil is derived as:

$${R}_{coil} = \frac{{U}_{coil}}{current} \qquad ( 4 )$$

This value is resistance R_{coil} which the coil of the metering unit actually has. Resistance R_{coil} of the coil may be calculated as a proportion of the measured, total resistance of the circuit of the metering unit. Resistance R_{coil} of the coil includes electrical setpoint resistance R_{coil,setpoint}, which the coil is to have according to the manufacturing requirements, tolerance resistance R_{coil,tolerance}, by which the resistance of the coil deviates from the setpoint resistance due to manufacturing, and thermal resistance Rₜₕₑᵣₘₐₗ which the coil has on the basis of its thermal state. The following thus applies:

R_{coil}=R_{coil,setpoint}+R_{coil,tolerance}+Rₜₕₑᵣₘₐₗ (5)

Similarly to the resistance of the coil according to equation (5), a resistance Rₒᵤₜₚᵤₜ_{_{—}}_{stage} of the output stage in equation (6) and a resistance of a conducting-state voltage U_{diode} through the diode in equation (7) are derived from particular setpoint values R_{coil,setpoint}, Rₒᵤₜₚᵤₜ_{_{—}}_{stage,setpoint}, U_{diode,setpoint} for these variables R_{coil}, Rₒᵤₜₚᵤₜ_{_{—}}_{stage}, U_{diode} as well as tolerance-related deviations R_{coil,tolerance}, Rₒᵤₜₚᵤₜ_{_{—}}_{stage,tolerance}, U_{diode,tolerance} for the variables which may result, for example, due to manufacturing-specific or supplier-specific influences.

Rₒᵤₜₚᵤₜ_{_{—}}_{stage}=Rₒᵤₜₚᵤₜ_{_{—}}_{stage,setpoint}+Rₒᵤₜₚᵤₜ_{_{—}}_{stage,tolerance} (6)

U_{diode}=U_{diode,setpoint}+U_{diode,tolerance} *7)

Temperature T_{coil} of the coil is calculated via the thermal electrical resistance of the coil of the metering unit, alpha being a temperature coefficient which is dependent on the inductance and therefore on the material of the coil:

$${T}_{coil} = ( \frac{{R}_{thermal} + {R}_{coil , setpoint} + {R}_{coil , tolerance}}{{R}_{coil , setpoint} + {R}_{coil , tolerance}} - 1 ) * \frac{1}{alpha} + 20 ° C . \qquad ( 8 )$$

Since the coil of the metering unit may be subject to manufacturing-related tolerances with regard to its electrical resistance, its individual tolerance resistance R_{coil,tolerance} is ascertained. It is furthermore provided to ascertain a specific individual conducting-state voltage through the diode as well as a specific individual resistance of the output stage, which may be subject to tolerances, for the purpose of increasing an accuracy in relation to the FTE function. Once the coil of the metering unit is in a thermally known state after the internal combustion engine is turned off, or directly after an energizing of the metering unit begins following a very long shutdown phase of the motor vehicle, the specific individual tolerance resistance R_{coil,tolerance} of the metering unit is known, learned and/or calculated, taking the following approach into account: T_{coil}=T_{ZME}=T_{engine}=.

In this case, it is assumed that the temperatures of the coil, the metering unit (T_{ZME}) and the engine (T_{engine})) are the same. In one embodiment, for example, T_{engine}=20° C. However, another suitable temperature may also be used, in which the aforementioned temperatures T_{coil}, T_{ZME} and T_{engine} are the same. Under the provided time and thermal conditions, the deviation of tolerance resistance R_{coil,tolerance} from electrical setpoint resistance R_{coil,setpoint} is only manufacturing-related and does not create any thermally related difference. In addition, the proportion of thermal resistance which may also create deviations in this initialization approach is compensated by equation (9) if the initialization does not take place at 20° C.:

R_{thermal,init}=└(T_{coil}-20° C.)*alpha+1)┘*R_{coil,setpoint}-R_{coil,setpoint} (9)

R_{thermal,init} is therefore the proportion which adjusts the tolerance resistance of the coil of the known coil temperature to 20° C.

The tolerance resistance is then determined as follows:

R_{coil,tolerance}=R_{coil}−R_{coil,setpoint}−R_{thermal,init} (10)

Accordingly, the temperature of the coil may be calculated, using equation (8), from a resistance of the coil in equation (5), which includes the setpoint resistance, the tolerance resistance and the thermal resistance.

For further calculation, a specific individual resistance value R_{coil,tolerance} of the metering unit is calculated together with the other specific individual tolerance proportions. In this case, equations (1) and (2) and equation (3) are used in equation (4) and in equation (5), together with equation (6) and equation (7).

$$\begin{matrix}{R}_{thermal} + {R}_{coil , tolerance} + {R}_{output \_ stage , tolerance} * pulse duty cycle + \frac{{U}_{diode , tolerance}}{current} * ( 1 - pulse duty cycle ) = \frac{{U}_{battery} * pulse duty cycle}{current} - ( {R}_{cable \_ harness} + {R}_{connector} + {R}_{measuring \_ resistor} ) - {R}_{output \_ stage} * pulse duty cycle - \frac{{diode}_{setpoint}}{current} ( 1 - pulse duty cycle ) & ( 11 ) \\ {R}_{tolerance , current 1} = \frac{{U}_{battery} * pulse duty cycle1}{current1} - ( {R}_{cable \_ harness} + {R}_{connector} + {R}_{measuring \_ resistor} ) - {R}_{output \_ stage} * pulse duty cycle1 - \frac{{U}_{diode , setpoint}}{current1} ( 1 - pulse duty cycle ) - {R}_{thermal , init} & ( 12 )\end{matrix}$$

where equation (9) is taken into account for R_{thermal,init}.

A thermal resistance proportion, which is presented on the basis of the presented equations (11) and (12) and which may also be created on the basis of deviations, is compensatable, for example with the aid of the aforementioned equation (8). One result is a total tolerance initialization value for a first current level current1.

Similarly, a tolerance initialization value is determined for another current level current2, current3, for example for one or two additional current levels current2, current3, for example at a point in time of a setting of an actuator safeguard of the metering unit, i.e., when terminal K15 is on and the internal combustion engine is off. This results in the following three equations:

$$\begin{matrix}{R}_{tolerance \_ current 1} = {R}_{coil , tolerance} + {R}_{output \_ stage , tolerance} * pulse duty cycle1 + \frac{{U}_{diode , tolerance}}{current1} * ( 1 - pulse duty cycle1 ) & ( 13 ) \\ {R}_{tolerance \_ current 2} = {R}_{coil , tolerance} + {R}_{output \_ stage , tolerance} * pulse duty cycle2 + \frac{{U}_{diode , tolerance}}{current1} * ( 1 - pulse duty cycle2 ) & ( 14 ) \\ {R}_{tolerance \_ current 3} = {R}_{coil , tolerance} + {R}_{output \_ stage , tolerance} * pulse duty cycle3 + \frac{{U}_{diode , tolerance}}{current1} * ( 1 - pulse duty cycle3 ) & ( 15 )\end{matrix}$$

Tolerance resistances R_{tolerance,current1}, R_{tolerance,current2} and R_{tolerance,current3} of the current levels current1, current2 and current3 presented on the basis of equations (13) through (15) are ascertainable using a control unit. It is furthermore provided that an equation system which includes the three equations having the three unknown tolerance values (R_{coil,tolerance}, Rₒᵤₜₚᵤₜ_{_{—}}_{stage,tolerance} and U_{diode,tolerance}) may be solved as possible tolerance-related deviations of the variables R_{coil}, Rₒᵤₜₚᵤₜ_{_{—}}_{stage} and U_{diode} and may be calculated in the control unit. Based on a known tolerance situation, it is also possible to omit at least one equation (13) through (15) for a tolerance resistance (R_{tolerance,current1}, R_{tolerance,current2}, R_{tolerance,current3}) of a current level current1, current2, current3 to meet the need for storage space and computing time and to not calculate a tolerance of the output stage. Instead, it is provided to initialize a conducting-state voltage through the diode on the basis of known influencing factors such as temperature, current and supplier. Due to their time influences, the ascertained tolerance proportions represent resistances of the circuit of the metering unit via the pulse duty factor better than do the individual initialization values in the FTE function, which makes it possible to increase the ascertainment accuracy for the temperature of the fuel. Under certain circumstances, it may be sufficient to initialize tolerance values R_{coil,tolerance}, Rₒᵤₜₚᵤₜ_{_{—}}_{stage,tolerance} and U_{diode,tolerance} only once over a life cycle of the internal combustion engine.

It is usually sufficient to carry out the initialization of the value of tolerance resistance R_{coil,tolerance} only once over a life cycle of the metering unit. The learned tolerance resistance of the coil of the metering unit is stored in a memory, which is designed, for example, as an EEPROM of a control unit. The learned and stored tolerance resistance R_{coil,tolerance} of the coil of the metering unit is taken into account for future observations of the resistance in the circuit of the metering unit, for example during vehicle startups.

In one embodiment of the present invention, different values may be taken into account for a heat exchange and therefore a heat transfer of different components of the injection system. The following applies to the heat exchange between the coil and the engine compartment:

$${Q}_{engine \_ compartment} = \frac{{T}_{coil} - {T}_{engine \_ compartment}}{{R}_{thermal , engine \_ compartment}} \qquad ( 16 )$$

The heat exchange between the coil and the high pressure pump is as follows:

$${Q}_{pump} = \frac{{T}_{coil} - {T}_{pump}}{{R}_{thermal , pump}} \qquad ( 17 )$$

The heat exchange between the coil and the fuel is:

$${Q}_{fuel} = \frac{{T}_{coil} - {T}_{fuel}}{{R}_{thermal , fuel}} \qquad ( 18 )$$

The coil is electrically heated by a pulse width modulated activation of the control unit. The following applies to an electrical heat exchange:

Q_{electrical}=current²*R_{coil} (19)

T_{coil} is the temperature of the coil, R_{coil} is the electrical resistance of the coil, Tₚᵤₘₚ is the temperature of the high pressure pump, T_{engine}_{_{—}}_{compartment} is the temperature of the engine compartment. The three variables, R_{thermal,engine}_{_{—}}_{compartment}, R_{thermal,pump} and R_{thermal,fuel}, represent the thermal resistance during the heat transfer from the coil to the relevant position (unit: ° C./W).

The following is obtained at the coil of the metering unit as the heat maintenance equation:

Q_{electrical}=Q_{engine}_{_{—}}_{compartment}+Q_{fuel}+Qₚᵤₘₚ (20)

Consequently, the temperature of the fuel is ascertained from calculated temperature T_{coil} of the coil with the aid of additional corrections, which result from a vehicle type-specific heat exchange between the high pressure pump, the engine compartment and the metering unit as well as its coil, for example the heat exchange within the metering unit.

Similarly to the previous procedure, the temperature of the fuel ascertained in this way may be used in the control unit, for example to regulate injections by the injection system.

All thermodynamic equations (16) through (20) result in the. following for the temperature of the fuel:

$${T}_{fuel} = {T}_{coil} - {R}_{thermal , fuel} * ( {R}_{coil} * {Current}^{2} - \frac{{T}_{coil} - {T}_{pump}}{{R}_{thermal , pump}} - \frac{{T}_{coil} - {T}_{engine \_ compartment}}{{R}_{thermal , engine \_ compartment}} ) \qquad ( 21 )$$

Among other things, temperature T_{coil} from equation (8), which is calculated from the electrical resistance of the coil from equation (5), is incorporated into equation (21). This temperature includes resistances Rₜₕₑᵣₘₐₗ and R_{coil,tolerance}, which, in turn, are resistances of components of the circuit of the metering unit. The temperature of the coil is therefore calculated from the proportion of the resistance of the coil in the total resistance of the circuit of the metering unit.

The temperatures and resistances used to calculate temperature T_{fuel} may be ascertained ahead of time and also calculated concurrently with the method and/or measured by thermometers as well as by electrical measuring equipment.

The example system according to the present invention is designed to carry out all steps of the presented method. Individual steps in this method may also be carried out by individual components of the system. Furthermore, functions of the system or functions of individual components of the system may be implemented as method steps. It is also possible to implement method steps as functions of at least one component of the system or as functions of the overall system.

Further advantages and embodiments of the present invention are derived from the description and the attached drawings.

It is understood that the aforementioned features and the features explained below may be used not only in the particular specified combination but also in other combinations or alone without departing from the scope of the present invention.

### BRIEF DESCRIPTION OF THE DRAWINGS

FIG. 1 shows a schematic representation of one specific embodiment of a system according to the present invention.

FIG. 2 shows a schematic representation of a detail of a circuit of a metering unit.

### DETAILED DESCRIPTION OF EXAMPLE EMBODIMENTS

The present invention is represented schematically in the drawings on the basis of specific embodiments and is described in greater detail below with reference to the figures.

The figures are described conjunctively and generally; the same reference numerals identify the same components.

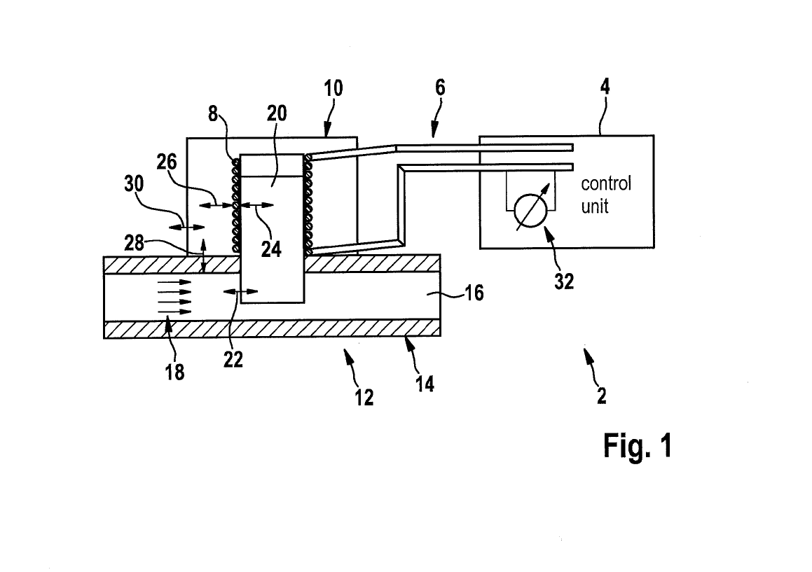

The first specific example embodiment of a system 2 according to the present invention, which is illustrated schematically in FIG. 1, includes a control unit 4, with the aid of which a specific embodiment of the method according to the present invention is to be carried out. This control unit 4 is connected to a coil 8 of a metering unit 10 of an injection system 12 of a motor vehicle via cables 6. FIG. 1 furthermore shows a schematic representation of a high pressure pump 14 of injection system 12 for delivering fuel. The fuel flows though a channel 16 of high pressure pump 14, which is indicated by four arrows 18 in FIG. 1.

During a current feed to coil 8, which may take place starting from a control unit 4 via cables 6, a magnetic field is induced by coil 8 of metering unit 10, thereby changing a position of a slide valve 20, which projects at least partially into channel 16 of high pressure pump 14. By positioning slide valve 20 it possible to regulate a size of a cross section of channel 16 and thus meter a quantity of fuel flowing through channel 16 of high pressure pump 14 with the aid of metering unit 10.

In FIG. 1, double arrows each represent gradients for a value of a first heat exchange 22 between the fuel and the slide valve, for a value of a second heat exchange 24 between slide valve 20 and coil 8, for a value of a third heat exchange 26 between metering unit 10 and coil 8, for a fourth value of a heat exchange 28 between high pressure pump 14 and metering unit 10, as well as for a value of a fifth heat exchange 30 between an engine compartment of the internal combustion engine of the motor vehicle and metering unit 10. The aforementioned values for the heat exchange may also be taken into account within the scope of the example method.

FIG. 1 furthermore shows an electrical measuring device 32 as a component of control unit 4, which may be used to ascertain at least one electrical parameter, i.e., a current and/or a voltage, of metering unit 10 of a circuit of metering unit 10 and/or of coil 8 for the purpose of determining the temperature of the fuel within the scope of the example method according to the present invention.

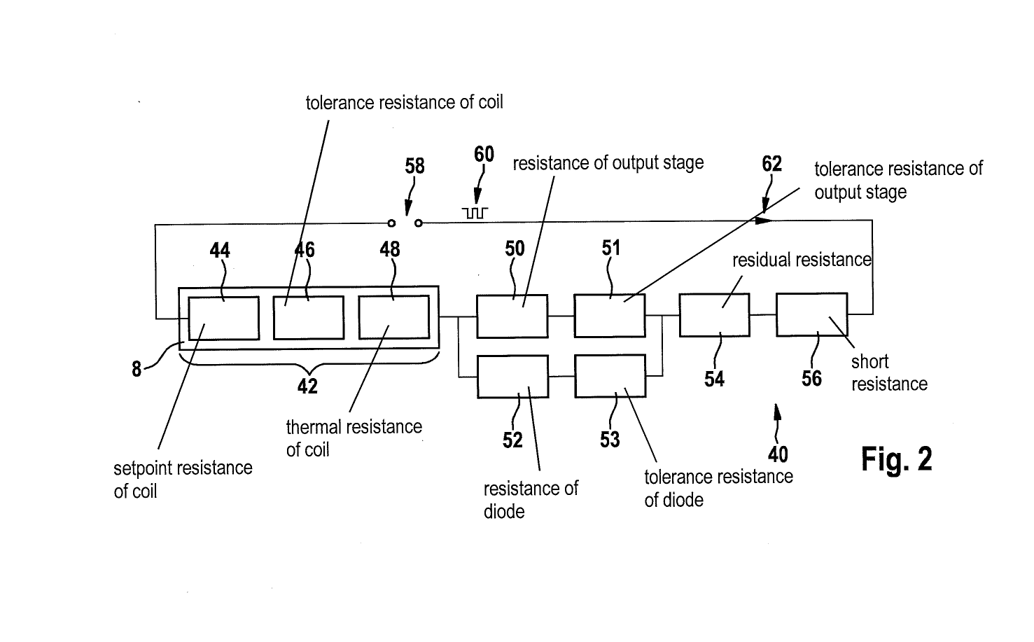

Circuit 40 of metering unit 10, which is presented on the basis of FIG. 1, is illustrated schematically in FIG. 2. This circuit 40 includes a real resistance 42 R_{coil} of coil 8, which, in turn, includes a setpoint resistance 44 R_{coil,setpoint} of coil 8, a tolerance resistance 46 R_{coil,tolerance} of coil 8 as well as a thermal resistance 48 R_{coil,thermal} of coil 8. Circuit 40 of metering unit 10 furthermore includes a resistance 50 Rₒᵤₜₚᵤₜ_{_{—}}_{stage} of the output stage and a tolerance resistance 51 Rₒᵤₜₚᵤₜ_{_{—}}_{stage,tolerance} of the output stage (only during the activation phase, in which battery 58 supplies coil 8 from FIG. 1, one time interval corresponding to one pulse duty factor), as well as a resistance 52 R_{diode} of the diode, which is connected in parallel thereto, and a tolerance resistance 53 R_{diode,tolerance} of the diode (only during the deactivation phase, in which battery 58 is disconnected by a switch from coil 8 from FIG. 1, a time interval is 1—pulse duty factor). Circuit 40 also includes a residual resistance 54 R_{residual}, which includes the resistance of a cable harness R_{cable harness} and at least one connector R_{connector}, as well as a shunt resistance 56 or measuring shunt resistance Rₛₕᵤₙₜ. These aforementioned resistances of components of circuit 40 may be taken into account for determining the temperature of the fuel. Circuit 40 of metering unit 10 is connected to a battery 58, which supplies circuit 40 with a pulse width modulated activation 60, so that a current 52 I_{ZME} of metering unit 10 flows through circuit 40.

In carrying out the example method according to the present invention, the temperature of the fuel in injection system 12 is determined as a function of a temperature of coil 8 of metering unit 10, taking into account the resistance in circuit 40 of metering unit 10. The total resistance of the circuit of the metering unit is measured by control unit 4. In addition, control unit 4 calculates a proportion of a resistance R_{co}n of coil 8 in the total resistance of circuit 40. The temperature of coil 8 is calculated by control unit 4 from the proportion of resistance R_{coil} of coil 8 in the total resistance of circuit 40.

In carrying out the example method, a voltage applied to coil 8 during an activation phase and a voltage U_{coil,off} applied to coil 8 during a deactivation phase as well as a pulse duty factor may furthermore be taken into account.

1-8. (canceled)

9. A method for determining a temperature of fuel in an injection system, comprising:
ascertaining a temperature of the fuel as a function of a temperature of a coil of a metering unit of the injection system;
measuring a total resistance of a circuit of the metering unit; and
calculating a proportion of a resistance of the coil in the total resistance of the circuit, the temperature of the coil being calculated from the resistance of the coil.

10. The method as recited in claim 9, wherein the total resistance of the circuit of the metering unit includes resistances of individual components of the circuit including the resistance of the coil, a resistance of an output stage, a tolerance resistance of the output stage, a resistance of a diode, a tolerance resistance of the diode, a residual resistance, a resistance of a cable harness, and at least one of a resistance of a connector and a shunt resistance.

11. The method as recited in claim 9, wherein a voltage applied to the coil is used during an activation phase and a deactivation phase, taking a pulse duty factor into account.

12. The method as recited in claim 9, wherein the resistance of the coil includes a setpoint resistance of the coil, a tolerance resistance of the coil and a thermal resistance of the coil.

13. The method as recited in claim 12, wherein the tolerance resistance is determined when the internal combustion engine is turned off under thermally known conditions.

14. The method as recited in claim 9, wherein in ascertaining the temperature of the fuel, a value is taken account for a heat exchange at least one of between the coil and an engine compartment, between the coil and a high pressure pump, between the fuel and the high pressure pump, between a slide valve of the metering unit, and the coil, between the fuel and the slide valve and between the metering unit and the high pressure pump.

15. The method as recited in claim 9, wherein the following equation is used for calculating the temperature T_{fuel} of the fuel:
$${T}_{fuel} = {T}_{coil} - {R}_{thermal , fuel} * ( {R}_{coil} * {Current}^{2} - \frac{{T}_{coil} - {T}_{pump}}{{R}_{thermal , pump}} - \frac{{T}_{coil} - {T}_{engine \_ compartment}}{{R}_{thermal , engine \_ compartment}} )$$
where T_{coil} is the temperature of the coil, R_{coil} is the electrical resistance of the coil, Tₚᵤₘₚ is a temperature of a high pressure pump and T_{engine-compartment} is a temperature of an engine compartment, the three variables R_{thermal,engine}_{_{—}}_{compartment}, R_{thermal,pump} and R_{thermal,fuel} representing thermal resistances during a heat transfer from the coil to a relevant position (unit: ° C./W) and a current flowing through the circuit of the metering unit being taken into account.

16. A system for determining a temperature of fuel in an injection system, comprising:
a control unit to ascertain the temperature of the fuel as a function of a temperature of a coil of a metering unit of the injection system, measure a total resistance of the circuit of the metering unit, and calculate a proportion of a resistance of the coil in the total resistance of the circuit, the control unit calculating the temperature of the coil from the resistance of the coil.
